(19) United States
(12) Patent Application Publication
(10) Pub. No.: US 2021/0390530 A1
(43) Pub. Date: Dec. 16, 2021

(54) SMART CARD PROVIDING SELECTABLE PAYMENT OPTIONS

(71) Applicant: Bank of America Corporation, Charlotte, NC (US)

(72) Inventor: Saurabh Gupta, New Delhi (IN)

(21) Appl. No.: 16/897,405

(22) Filed: Jun. 10, 2020

(51) Int. Cl. G06Q 20/34; G06Q 40/02; G06Q 20/42; G06Q 20/40; H04L 9/32

(52) U.S. Cl. CPC G06Q 20/3572; G06Q 20/3415; G06Q 20/352; G06Q 40/02; G06F 3/0482; G06Q 20/4012; H04L 9/3234; G06Q 2220/00; G06Q 20/42

(57) ABSTRACT

Typically, online transactions, such as online purchases of products or services require entering sensitive transaction information into a third-party web browser or application. This may expose sensitive transaction information to an increased risk of inadvertent disclosure. Apparatus and methods are provided for a smart card which enables users to securely complete online transactions without entering any sensitive transaction information into a third-party system. The smart card may include a microprocessor and wireless interface. The wireless interface may provide wireless communication capabilities and the ability to initiate online payments based on information captured by the touch-sensitive screen. The wireless interface will receive communications from a merchant or issuer bank requesting payment. The microprocessor may be configured to offer multiple selectable payment options to the user.

### FIELD OF TECHNOLOGY

Aspects of the disclosure relate to a smart payment card with enhanced communication features.

### BACKGROUND OF THE DISCLOSURE

When conducting online transactions and payments, users typically enter credit card information or other sensitive transaction information into a web browser or mobile application. However, doing so increases a risk that the sensitive transaction information will be compromised. For example, security associated with the web browser may be substandard or the security of another network system utilized by a mobile application may be exposed. These potential security flaws associated with third-party systems that transmit and capture sensitive transaction information may increase the exposure risk.

In addition to security breaches of even reputable third-party systems, there are fraudulent actors who design illegitimate systems which attempt to induce users to enter sensitive transaction information into legitimate-looking webpages. These illegitimate systems are typically designed to appear as a reputable system or webpage, and thereby induce the user to enter sensitive transaction information. The illegitimate system may then expose the captured sensitive transaction information for self-serving, fraudulent, pecuniary gain.

Recently, use of digital wallets has proliferated. These digital wallets are typically associated with more reliable security measures than prior systems. However, even use of a digital wallet does not fully address the challenges in securing sensitive transaction information. For example, when using digital wallets, sensitive transaction information may still be captured using third-party applications that may track use and content of the sensitive transaction information. By increasing the number of parties that handle the sensitive transaction information, there is an associated increase in risk that the sensitive transaction information will be inadvertently disclosed.

It would be desirable to provide more secure apparatus and methods for users to make online payments without providing sensitive transaction information to any third-party system. In addition to reducing the exposure risk of sensitive transaction information, such apparatus and methods may improve the user experience when making an online payment.

It would also be desirable to provide a variety of selectable options with regard to the payment such as delegating a payment to another party or making a partial payment.

### SUMMARY OF THE DISCLOSURE

Aspects of the disclosure relate to a smart card with self-contained transaction architecture for increasing transactional efficiency and security. The smart card may include a microprocessor, a touch-sensitive screen, a power source for the microprocessor and the touch-sensitive screen, a wireless interface configured to provide wireless communication to a payment gateway, a payment interface, and a non-transitory memory storing computer-executable instructions.

The instructions, when run on the microprocessor, may be configured to receive information via the wireless interface. The information received may include a recipient and a payment amount.

The instructions, when run on the microprocessor, may be configured to display the information received on the touch-sensitive screen. The instructions, when run on the microprocessor, may be configured to display selectable payment options on the touch-sensitive screen. For example, the smart card may display an option to make a payment, confirm a payment amount, delegate a payment, or edit a payment amount.

The smart card may be configured to transmit to the payment gateway, via the payment interface and wireless interface, payment instructions to execute a payment.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative apparatus in accordance with principles of the disclosure;

FIG. 2 shows illustrative apparatus in accordance with principles of the disclosure;

FIG. 3 shows illustrative process flow in accordance with principles of the disclosure;

FIG. 4 shows illustrative system architecture in accordance with principles of the disclosure; and

FIG. 5 shows illustrative system architecture in accordance with principles of the disclosure.

FIG. 6 shows illustrative apparatus in accordance with the principles of the disclosure.

### DETAILED DESCRIPTION

A smart card with self-contained transaction architecture is provided. The card may increase transactional efficiency and security. For example, efficiency may be increased by eliminating the need to use a device external to the card for executing transactions. Security may be increased by providing a system with dedicated transactional hardware, software, and/or communication channels. Such a system may be associated with a decreased risk of infection with malware, spyware, or other security risk factors.

The smart card may be part of a system for increasing transactional efficiency and security. The card may include a microprocessor, a touch-sensitive screen, a power source for the microprocessor and the touch-sensitive screen, a wireless interface configured to provide wireless communication to a payment gateway, and a non-transitory memory storing computer-executable instructions. The instructions, when run on the microprocessor, may be configured to perform some or all of the disclosed features of the card.

The smart card may include metal and/or plastic. The card may have dimensions that conform to the ISO/IEC 7810 ID-1 standard. The dimensions may, in some embodiments, be no greater than 86 millimeters×54 millimeters×0.8 millimeters.

In some embodiments of the smart card, the wireless interface may include a wireless network interface card (“NIC”).

In some embodiments, the power source may be rechargeable. The power source may recharge via solar energy, inductive charging, a charging port, and/or any other suitable charging mechanism.

In some embodiments, the smart card may include a payment interface to resolve different payment options to different secure payment gateways.

In some embodiments, the microprocessor, the power source, the wireless interface, the payment interface, and/or the memory may be embedded in the smart card. The touch-sensitive screen may be affixed to the smart card and may be exposed on a surface of the smart card.

The smart card may include hardware and associated integrated circuitry for users to complete online payments without entering sensitive transaction information into a third-party system such as a web browser or other software applications. The smart card may include a touch-sensitive screen. The smart card may include a keypad. The user may depress keys on the keypad or use the touch-sensitive screen to enter information directly into the smart card.

The smart card may include a microprocessor and a Network Interface Card (“NIC”). The microprocessor and associated NIC may enable the card to establish a communication channel. Over the secure communication channel, the smart card may interact directly with a secure system for making a payment. The secure system may be operated by an issuer of the smart card or an acquirer of the merchant. The microprocessor may have a thickness that is not greater than 0.25 millimeters (“mm”). The microprocessor may control overall operation of the smart card and its associated components.

The smart card may include various other hardware components. Such components may include a battery, a speaker, and antenna(s). The smart card may include RAM, ROM, an input/output (“I/O”) module and a non-transitory or non-volatile memory.

The I/O module may include a microphone which may accept user provided input. The I/O module may include one or more of a speaker for providing audio output and a display for providing textual, audiovisual and/or graphical output.

Software may be stored within the non-transitory memory and/or other storage media. Software may provide instructions, that when executed by the microprocessor, enable the smart card to perform various functions. For example, software may include an operating system, application programs, web browser and a database. Alternatively, some or all of computer executable instructions of the smart card may be embodied in hardware or firmware components of the smart card.

Application programs, which may be used by the smart card, may include computer executable instructions for invoking user functionality related to communication, authentication services, and voice input and speech recognition applications. Application programs may utilize one or more algorithms that encrypt information, process received executable instructions, interact with an issuer or acquirer bank systems, perform power management routines or other suitable tasks.

The smart card may include a pressure sensitive button. The pressure sensitive button may have a thickness that is not greater than 0.8 mm. A user may actuate the pressure sensitive to power on or off one or more components of the smart card. For example, actuating the pressure sensitive button may activate the microprocessor, NIC, touch-sensitive screen, or keypad of the smart card.

The smart card may operate in a networked environment. The smart card may support establishing communication channels with one or more issuer or acquirer bank systems. The smart card may connect to a local area network (“LAN”), a wide area network (“WAN”) a cellular network or any suitable communication network. When used in a LAN networking environment, the smart card may be connected to the LAN through a network interface or adapter. The NIC may include the network interface or adapter.

When used in a WAN networking environment, the smart card may include a modem or other means for establishing communications over a WAN, such as the Internet. The NIC may include the modem. It will be appreciated that the existence of any of various well-known protocols such as TCP/IP, Ethernet, FTP, HTTP and the like is presumed.

The smart card may be operational with numerous other general purpose or special purpose computing system environments or configurations. Examples of well-known computing systems, environments, and/or configurations that may be suitable for use with the invention include, but are not limited to, other smart cards, personal computers, server computers, hand-held or laptop devices, tablets, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The smart card may utilize computer-executable instructions, such as program modules, being executed by a computer. Generally, program modules include routines, programs, objects, components, data structures, etc. that perform particular tasks or implement particular abstract data types. The smart card may be operational with distributed computing environments where tasks are performed by remote processing devices that are linked through a communications network. In a distributed computing environment, program modules may be located in both local and remote computer storage media including memory storage devices.

The smart card may include one or more batteries. A battery of the smart card may be flexible. The battery may be a power source for electronic hardware components of the smart card. For example, the battery may supply power to a keypad, touch-sensitive screen, NIC and microprocessor. The battery may have a thickness that is not greater than 0.5 mm.

In some embodiments, the smart card may include an electrical contact. The battery may be recharged via an electrical contact when the smart card is inserted into an Automated Teller Machine (“ATM”). An electrical contact may be constructed using any suitable material that conducts or transfers electricity. The smart card may include a plurality of electrical contacts. An electrical contact may be accessible on any suitable face of a housing of the smart card. The contact may be utilized to transfer electrical charge to the rechargeable battery when the smart card is inserted into a card reader of the ATM.

In some embodiments, the smart card's power source may include high frequency signals received from an ATM or other network node. The smart card may be configured to utilize received high frequency signals to recharge the battery or provide power to other hardware components of the smart card. The high frequency signals may conform to a standardized near field communication (NFC) communication standard.

Illustrative NFC protocols include European Computer Manufacturers Association Document Nos. 340 and 352 and International Organization for Standardization Document Nos. 18092 and 21481. All these standards are hereby incorporated by reference herein in their entireties.

The smart card may include a housing. The housing may provide a protective layer for internal components of the smart card. The housing may be flexible. The housing may be constructed from plastic or other suitable materials. The housing may define a form factor of the smart card. The microprocessor and other components of the smart card may be embedded in and protected by the housing. The smart card may include wireless interface embedded in the housing. The wireless interface may include a NIC. The smart card may include a touch-sensitive screen on an outside surface of the housing. The smart card may include a keypad mounted on an outside surface of the housing.

The housing and the keypad or touch-sensitive screen collectively may have a thickness that is not greater than 0.8 millimeters (“mm”) and a surface area that is not greater than 86 mm×54 mm. Such a compact form factor may allow the smart card to be inserted into traditional card readers and function as a typical debit or credit card.

For example, the user may use the smart card to access an ATM and withdraw cash. The user may also use the smart card to make a purchase at a traditional brick and mortar merchant location. The user may pay for such a purchase using a conventional point-of-sale (“POS”) terminal at the brick and mortar location. When the smart card is inserted into card reader of an ATM or POS terminal a battery of the smart card may be recharged.

The smart card may include a touch-sensitive screen. The touch-sensitive screen may capture finger motions. The finger motions may include payment information entered by a user of the smart card. The microprocessor may capture the finger motions entered using the touch-sensitive screen.

The smart card may include specialized software (executable by the microprocessor) for automatic conversion of finger motions as they are input by the user on the touch-sensitive screen.

The touch-sensitive screen may utilize resistive touch technology to detect user touch points. Screens constructed using resistive touch technology include an upper layer (which is touched by the user) spaced apart from a bottom layer. When the user touches the screen, the upper layer contacts the bottom layer, generating an electrical signal. Screens constructed using resistive touch technology only require the application of pressure and do not require application of heat or electrical charge to detect a touch point. Resistive-touch technology is also relatively less expensive than other touch sensing technologies.

The touch-sensitive screen may utilize capacitive touch technology to detect user touch points. Screens constructed using capacitive touch technology may identify where a user touches based on detecting an electrical disturbance created when the user touches the screen. The human body is an electronical conductor and, contact with another conducting surface such as the surface of a touch-sensitive screen, typically generates a detectable electrical disturbance. Capacitive touch technology detects the electrical disturbance and determines where on the screen the user touched.

The touch-sensitive screen may utilize any suitable touch detection technology such as surface acoustic wave, optical imaging, infrared acrylic projection or acoustic pulse recognition technologies.

The smart card may include a touch-sensing controller for detecting a touched location. The touch-sensing controller may include an application-specific integrated circuit (ASIC) chip and a digital signal processor (DSP) chip.

In some embodiments, the touch-sensitive screen may provide “single-touch” functionality. In some embodiments, the touch-sensitive screen may provide “multi-touch” functionality. Single-touch functionality may detect input from one user touch on the touch-sensitive screen. For example, the touch-sensitive screen may display a list of payment options and the user may select one or the option by using a finger to touch the desired option. Single-touch functionality may also recognize double finger taps or a long-press functionality.

Multi-touch functionality may detect input from two or more simultaneous user touch points on the touch-sensitive screen. For example, a pinch-to-zoom feature is a multi-touch functionality.

The touch-sensitive screen may include nano-thin light emitting diode (“LED”) technology.

The touch-sensitive screen may include organic light emitting diode (“OLED”) technology. OLEDs are typically solid-state semiconductors constructed from a thin film of organic material. OLEDs emit light when electricity is applied across the thin film of organic material. Because OLEDs are constructed using organic materials, OLEDs may be safely disposed without excessive harm to the environment. Furthermore, OLEDs may be used to construct a display that consumes less power compared to other display technologies.

The touch-sensitive screen display may have a thickness that is not greater than 0.25 mm. The display may be flexible. The display may cover any suitable portion of a card surface. The display may cover an entire card surface.

The smart card may include a haptic response system. The haptic response system may provide a responsive force, vibration or movement in response to receiving a user's touch input. For example, the haptic response system may provide a responsive vibration to a user's touch-based selection of a payment option. The haptic response system may include an eccentric (unbalanced) rotating mass, a linear resonant actuator, a piezoelectric actuator or any other suitable hardware for providing a haptic response.

The microprocessor and associated hardware may interpret finger motions of the user applied to the touch-sensitive screen. For example, the microprocessor may translate the user's finger motions into digital payment information. The microprocessor may translate the user's finger motions into digital payment instructions. The microprocessor may encrypt the captured finger motions.

The microprocessor may formulate a set of payment instructions based on the captured finger motions. The microprocessor may formulate a set of payment instructions based on a user's touch-based selection of payment options displayed on the touch-sensitive screen. The user may provide touch-based confirmation of the accuracy of a payment instruction formulated by the microprocessor.

Illustrative finger motions entered using the touch-sensitive screen and encrypted by the microprocessor may include a personal identification number (“PIN”) associated with the smart card, selection of a payment option, selection of a payment recipient, and entry of a payment percentage or amount.

The touch-sensitive screen may have an inactive state. In the inactive state, the touch-sensitive screen is unable to capture data such as a user's touch inputs. When the touch-sensitive screen is in the inactive state, touch inputs including finger motions applied to the touch-sensitive screen are not captured by the microprocessor.

The touch-sensitive screen may have an active state. In the active state, the touch-sensitive screen is capable of capturing data, such as a user's touch inputs. The inactive state is a default state of the touch-sensitive screen. A default inactive state may avoid the microprocessor capturing inadvertent touch inputs.

The microprocessor may toggle the touch-sensitive screen from the inactive state to the active state. The microprocessor may toggle the touch-sensitive screen from the active state to the inactive state.

The smart card may include a touch-sensitive screen and a keypad. The keypad may be a mechanical keypad. In such embodiments, the housing and the keypad collectively may have a thickness that is not greater than 0.8 mm.

In some embodiments, the smart card may only include a touch-sensitive screen. The touch-sensitive screen may be configured to display a virtual keypad. The virtual keypad may include a display of input buttons that may be touch-selected by the user. In such embodiments, the housing and the touch-sensitive screen collectively may have a thickness that is not greater than 0.8 mm.

The smart card may include executable instructions stored in a non-transitory memory. The executable instructions, when run by the microprocessor may receive an input from another computer system via the wireless interface or input from a user. For example, the input may include a user's touch-based selection of a payment option displayed on a touch-sensitive screen. The input may include an alphanumeric code entered into a virtual or mechanical keypad. The executable instructions may formulate a set of sensitive payment instructions based on the input.

The formulated sensitive payment instructions may incorporate sensitive transaction information stored on the smart card. Sensitive transaction information, as used herein, may include:
Primary Account Number (“PAN”)
User name
Address
Telephone number
Expiration date
Service code
Authentication data
Personal Identification Number (“PIN”)
PIN Block
Card validation value (CVV), or any other three/four-digit card security code

The PAN is a typically multi-digit number printed on a front face of the smart card. The PAN may identify an issuer bank associated with the smart card. The smart card may correlate the specified issuer to the network address of a secure transaction gateway. The PAN may identify a user account at the issuer bank.

A PIN associated with the smart card may be a secret numeric password known only to the user of the smart card. The PIN may be used to authenticate the user before providing access to a secure payment processing system. A user may only be granted access to the secure system if the PIN provided matches a PIN stored on the secure system. For example, a PIN may be used to authenticate the smart card at an ATM. A PIN may also be used to authorize a digital signature implemented by an EMV chip.

A PIN Block includes data used to encapsulate a PIN during processing and transmission of the PIN. The PIN block defines the location of the PIN within the PIN block and how it can be extracted from the PIN block. A typical PIN block includes the PIN, the PIN length, and may contain subset of the PAN.

A service code may be a multidigit number. For example, in a three-digit service code, the first digit may indicate specific interchange rules that apply to the smart card. The second digit may specify authorization processing that is applied to the smart card when initiating transaction. Illustrative authorization processing may include requiring submission of a PIN, biometric feature, signature or a combination thereof. The second digit may also identify a secure payment gateway that is authorized to process payment instructions formulated by the smart card.

The third digit may specify a range of services that are authorized in connection with use of the smart card. For example, the third digit may indicate whether the smart card may be used at an ATM to withdraw cash or only to purchase goods or services from a merchant.

The smart card may receive a communication from a merchant or a card issuer regarding a payment due. In some embodiments, the smart card may be automatically registered to receive communications in response to a previous payment to the same merchant using the card. In some embodiments, the user may register the smart card with an issuer bank or with a merchant. In some embodiments, the user may register preapproved alternate payors with the issuer bank or the merchant. The communication may be pushed to the smart card.

The smart card may display any part of the communication on the touch-sensitive screen. The smart card may display one or more selectable payment options associated with the payment due on the touch-sensitive screen. For example, the smart card may display an option to make a payment, confirm a payment amount, delegate a payment, or edit a payment amount. The selectable options may include text, icons or any suitable graphical representations. The smart card may prompt entry of a PIN or other suitable authorization before displaying the communication or the selectable payment options.

The smart card may receive a user's touch-based selection of a payment option displayed on a touch-sensitive screen. In some embodiments, the payment option selected may be an option to delegate a payment. In response to the selection to delegate a payment the smart card may display a selectable list of preapproved alternate payors. The smart card may receive a selection of an alternate payor from the touch-sensitive screen.

In some embodiments, the payment option selected may be an option to make a payment. The smart card may determine the payment amount from the communication received from the merchant or card issuer. The smart card may display the payment amount on the touch-sensitive screen. The smart card may query the user to confirm the payment amount by touching the touch-sensitive screen.

In some embodiments, the payment option selected may be an option to edit the payment amount. The smart card may determine a payment amount via the payment request received from the merchant or the card issuer. The smart card may display the payment amount on the touch-sensitive screen. The smart card may query the user to edit the payment amount on the touch-sensitive screen. The smart card may receive an edited payment amount via the touch-sensitive screen.

The smart card may determine an identity of a merchant, an identify of a product/service, and an amount of a payment based on communications received or the user input. The card may formulate payment instructions based on communications received or the input. The smart card may encrypt the payment instructions. Only the secure payment gateway may be capable of decrypting the payment instructions.

Using a wireless interface, the smart card may establish a direct communication channel with a secure payment gateway. A network address of the secure payment gateway may be identified in the sensitive payment instructions formulated by the smart card. The location of the secure payment gateway may be determined based on identity of the merchant.

The payment interface may identify the secure payment gateway based on a payment option. A payment interface may resolve different payment options to different payment gateways.

The smart card may transmit payment instructions that include sensitive transaction information directly to the secure payment gateway for processing. In some embodiments, the smart card may transmit the sensitive transaction information to the payment gateway in a separate communication, distinct from transmission of payment instructions. In some embodiments, the smart card may transmit the sensitive transaction information to a first payment gateway and transmit the payment instructions to a second payment gateway. A secure payment gateway may process the payment instructions thereby reducing an exposure risk of the sensitive transaction information.

The secure payment gateway may be operated by an issuer or an acquirer bank. The secure payment gateway may process a payment on behalf of a merchant. The secure payment gateway may credit an account of the merchant for the payment by the user of the smart card. The secure payment gateway may debit an account of the user of the smart card for the payment.

The smart card may receive confirmation from the secure payment gateway that the payment instructions have been successfully executed. For example, the secure payment gateway may communicate to the smart card via the wireless interface that the payment instructions generated by the smart card have been successfully executed.

The secure payment gateway may provide the smart card with confirmation that a payment is completed. The confirmation may be displayed on the touch-sensitive screen. In some embodiments, the user may be provided the option to enter additional information using touch-based selection of an option on a touch-sensitive screen, a virtual keypad or a mechanical keypad. The secure payment gateway may trigger the smart card to prompt for the additional information.

In some embodiments, the smart card may receive confirmation directly from a merchant computer system. After successfully processing the payment instructions, the secure payment gateway may push a notification to the merchant system confirming successful execution of the payment instructions.

The smart card may include a biometric reader. The microprocessor may require submission of a valid biometric feature before attempting to establish a communication channel with the secure payment gateway. The microprocessor may require submission of a valid biometric feature before submitting the payment instructions to the secure payment gateway.

In some embodiments, the microprocessor may require a touch-based confirmation from the user before transmitting payment instructions to the secure payment gateway. The touch-based confirmation may include the touch-sensitive screen displaying a confirmatory message and requiring the user to register confirmation by touching a target area of the touch-sensitive screen.

In some embodiments, the smart card may include a fingerprint reader embedded within, or underneath the touch-sensitive screen. The user may register confirmation of payment instructions by providing a fingerprint using the embedded fingerprint reader. The microprocessor may confirm whether the provided fingerprint matches a known fingerprint securely stored locally on the smart card. The microprocessor may display the target area associated with a confirmatory message overlaid above the embedded fingerprint reader. By pressing a finger against the target area, the user may register confirmation by touching a target area of the screen and simultaneously submit a fingerprint for verification.

A wireless interface of the smart card may include an inactive state. When in the inactive state, the wireless interface may be unable to connect to a communication channel or transmit data. The wireless interface may include an active state. In the active state, the wireless interface may be capable of connecting to a communication channel, receiving data or transmitting data. The microprocessor may toggle the wireless interface from the inactive state to the active state. The microprocessor may toggle the wireless interface from the active state to the inactive state.

For example, the microprocessor may detect that a valid PIN has been entered by the user of the smart card using the keypad. In response to receiving the valid PIN, the microprocessor may toggle the wireless interface from the inactive to the active state. In response to receiving invalid PIN, the microprocessor may maintain the wireless interface in the inactive state. In some embodiments, if the microprocessor detects a threshold number of invalid PIN entries, the microprocessor may lock the wireless interface.

The microprocessor may require a special code to unlock the wireless interface. The microprocessor may require that the smart card establish a wired connection to unlock the wireless interface. For example, the wireless interface may only be unlocked when the smart card is inserted into a card reader of an ATM. The smart card may also require entry of a valid PIN to access the ATM before unlocking the wireless interface.

The smart card may include a voice controller. The voice controller may generate an audio message confirming the microprocessors interpretation of the user's touch inputs applied to the touch-sensitive screen and captured by the input controller. The microprocessor may prompt the user to touch a target area of the screen to confirm an accuracy of the generated audio message. In response to receiving the user's confirmation, the microprocessor may generate payment instructions for executing the payment identified in the audio message.

The smart card may include a voice controller. The voice controller may generate an audio message confirming a substance of the encrypted payment instructions generated by the smart card. For example, the voice controller may generate an audible message that identifies an amount due.

The voice controller may generate this audible message before payment instructions and any associated sensitive payment information are transmitted to the secure transaction gateway. After the voice controller generates the audible message, the microprocessor may not transmit the encrypted payment instructions to the payment gateway until receiving authorization entered using the keypad or touch-sensitive screen. The authorization may be entered by pressing target keys on a keypad or virtual keypad, or by selecting a selectable option on the touch-sensitive screen to confirm that the user of the smart card wishes to proceed with the transaction.

In some embodiments, the microprocessor may prompt the user to touch a target area of the screen to confirm an accuracy of the generated audio message. In response to receiving the user's confirmation, the microprocessor may generate payment instructions for executing the payment identified in the audio message. In some embodiments, the audio message may itself specify one or more target authorization keystrokes. Illustrative target authorization keystrokes may include pressing two or more keys concurrently or a specified sequence of keys.

A system for improving transaction processing efficiency of an ATM is provided. The system may include a smart card having a thickness not greater than 0.8 mm and a surface area not greater than 86 mm×54 mm. The smart card may include hardware components such as a communication interface and a microprocessor. The smart card may include a user input system in electronic communication with the microprocessor. The user input system may include a touch-sensitive screen and an input controller. The input controller may capture touch inputs entered using the touch-sensitive screen.

The smart card may include a wireless interface. The wireless interface may be configured to communicate using any suitable wireless communication protocol. Exemplary wireless communication protocols may include Wi-Fi, ZigBee, cellular and NFC.

The smart card may include a microprocessor. The microprocessor may be configured to control overall operation of the smart card and its associated components. The smart card may include executable instructions stored in a non-transitory memory. The executable instructions, when run by the microprocessor, may configure the microprocessor to take actions or control operation of one or more components of the smart card.

The executable instructions, when run by the microprocessor may display payment options on the touch-sensitive screen. For example, the microprocessor may display an option to make a payment, confirm a payment amount, delegate a payment, or edit a payment amount. The selectable options may include text, icons or any suitable graphical representations. The microprocessor may prompt entry of a PIN or other suitable authorization before displaying the communication or the selectable payment options.

The executable instructions, when run by the microprocessor may formulate payment instructions. The microprocessor may encrypt the payment instructions. The microprocessor may formulate transaction instructions based on selection of a selectable options displayed on the touch-sensitive screen.

The executable instructions, when run by the microprocessor may formulate the encrypted payment instructions based on user input via the touch-sensitive screen or mechanical keypad. The microprocessor may formulate encrypted payment instructions based on information received via the wireless interface from a merchant or the card issuer.

The microprocessor may activate a wireless interface of the smart card. The wireless interface may include a NIC. Using the wireless interface, the microprocessor may establish a communication link with a secure payment gateway. A network address of the transaction gateway may be stored on the smart card. For example, the network address of a secure transaction gateway may be stored in firmware of the smart card's NIC.

In other embodiments, the smart card may include a payment interface. The payment interface may determine a network address of a secure payment gateway based on user input via the touch-sensitive screen or mechanical keypad. The payment interface may determine a network of a secure payment gateway based on communications received via the wireless interface. The payment interface may determine a network of a secure payment gateway based on a selected payment option. The payment interface may resolve different inputs to different payment gateways.

The payment interface may determine an appropriate payment gateway based on the identity of a merchant. For example, different merchants may be associated with different acquirer banks. Each of the acquirer banks may utilize different security or communication protocols. The payment interface may direct the smart card to a payment gateway that is compatible with the security or communication protocols utilized by a particular acquirer bank.

The payment interface may determine an appropriate payment gateway based on the amount of a payment. For example, a payment gateway that requires higher level security and authentication may be utilized for larger payments.

The executable instructions, when run by the microprocessor, may authenticate the smart card to the payment gateway over the secure communication channel. The microprocessor may transmit the encrypted payment instructions to the payment gateway. The payment gateway may then process the payment instructions received from the smart card. Processing payment instructions may include transmitting a payment request to the selected alternate payor.

Processing the payment instructions may include debiting an account of the smart card user an amount corresponding to the payment amount. After debiting a user account, the payment gateway may provide confirmation to the smart card and to the merchant.

By interacting with the payment gateway, the system insulates sensitive information from being exposed to potentially unsecure third-party systems. The smart card then securely communicates with a secure payment gateway to process the payment based on the information provided in the user input.

Methods for securing sensitive transaction information stored on a smart card are provided. Methods may include completing an online payment without transmitting sensitive transaction information directly to a merchant selling a product or any other third-party computer system. A third-party system may be defined as any system that is not operated by an issuer of the smart card. Methods may include, using a touch-screen of the smart card, selecting a payment option displayed on the touch-sensitive screen.

Methods may include generating payment instructions. The payment instructions may integrate sensitive transaction information stored locally on the smart card. Methods may include determining a network address of a secure payment gateway. Using a wireless interface of the smart card, methods may include establishing a secure communication channel with the secure payment gateway.

Methods may include transferring the transaction instructions to the secure payment gateway using the secure communication channel. The secure payment gateway may provide a secure interface, operated by an issuer of the smart card, for insulating the sensitive transaction information stored on the smart card from direct interaction with the merchant system. Because the sensitive transaction information is transmitted directly to the secure payment gateway, the sensitive transaction information is not exposed to any merchant or other third party-systems.

Methods may include capturing payment information using a touch-sensitive screen embedded in a smart card. The touch-sensitive screen may display payment options that may be selected by a user. The user may touch the one or more of the displayed payment options.

Based on the payment options touched (e.g., selected) by the user, the microprocessor may formulate payment instructions. Capturing the payment information may include capturing touch inputs of a user applied to the touch-sensitive screen. Capturing the payment information may include the microprocessor translating finger motions applied to the touch-sensitive screen into digital payment instructions.

Illustrative payment options include a selectable option to make a payment or delegate a payment. If the payment option selected is an option to delegate a payment the microprocessor may display a list of alternate payors to be selected. The user may select an alternate payor to whom a payment request is sent. If the payment option selected is the option to make a payment, the microprocessor displays on the touch screen a request for authorization. The authorization may be an alphanumeric code entered by the user. After authorization is confirmed the payment interface may initiate communication with the appropriate payment gateway.

The user may enter custom payment options. For example, using touch inputs, the user may instruct the microprocessor to display a virtual keypad on the touch-sensitive screen. The user may the touch displayed virtual keys to enter customized payment details. The user may also use touch inputs to navigate menus displaying payment options or details that may be selected by the user.

In some embodiments, the method may include using a payment interface. The payment interface may be configured to resolve selection of a merchant or a payment to a known secure merchant system. The payment interface may determine whether the merchant system is a system that meets security requirements set by the issuer of the smart card. The secure merchant system may securely process the payment instructions formulated by the smart card.

In some embodiments, before connecting to the secure merchant system, the smart card may obtain approval from an issuer bank for communicating with the secure merchant system. The smart card may use the wireless interface to request and receive approval from the issuer to communicate with the secure merchant system.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown and/or described herein. Method embodiments may omit steps shown and/or described in connection with illustrative methods. Method embodiments may include steps that are neither shown nor described in connection with illustrative methods. Illustrative method steps may be combined. For example, an illustrative method may include steps shown in connection with any other illustrative method.

Apparatus may omit features shown and/or described in connection with illustrative apparatus. Apparatus embodiments may include features that are neither shown nor described in connection with illustrative apparatus. Features of illustrative apparatus may be combined. For example, an illustrative apparatus embodiment may include features shown or described in connection with another illustrative apparatus/method embodiment.

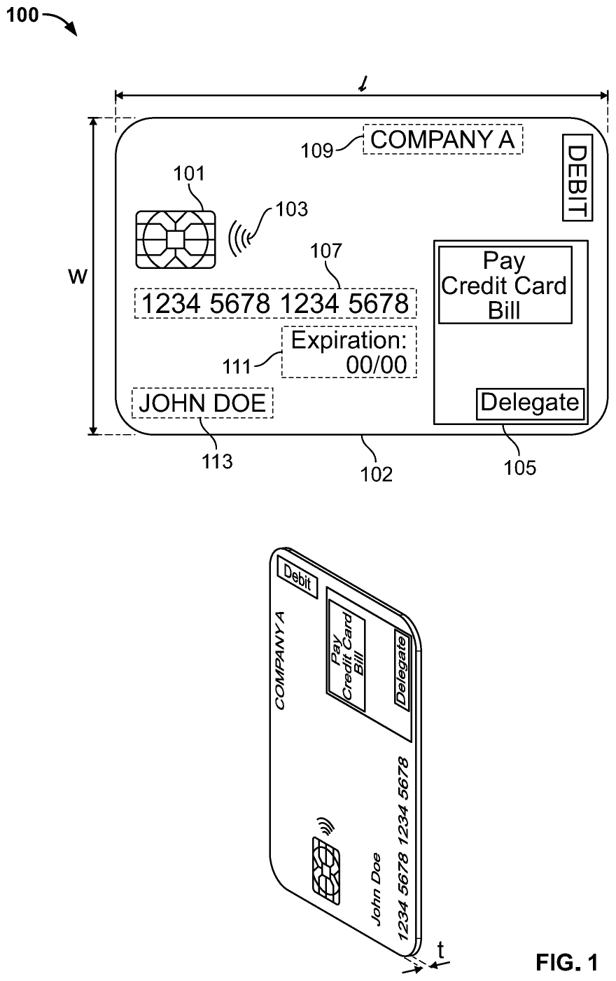

FIG. 1 shows an exemplary smart card, illustrative smart card 100. Smart card 100 includes touch-sensitive screen 105. Touch-sensitive screen 105 may be used by a user of smart card 100 to enter information. Exemplary information may include a selectable payment option.

Smart card 100 includes a microprocessor and other components for capturing, encrypting and storing information entered by a user. Smart card 100 may also include executable instructions for packaging information entered via touch-sensitive screen 105 into payment instructions that may be executed by a secure payment gateway. The executable instructions may also formulate the payment instructions based on sensitive payment information stored on the smart card.

FIG. 1 shows that smart card 100 includes chip 101. Chip 101 may provide an electrical contact that is accessible through housing 102. Chip 101 may provide an electrical contact for establishing a wired or contact based communication channel with an ATM or POS terminal when card 100 is inserted into a card reader of the ATM or POS terminal. Chip 101 may be an EMV chip.

Chip 101 may store a copy of information printed on a face of smart card 100. For example, chip 101 may store PAN 107, user name 113, expiration date 111 and issuing bank 109. Chip 101 may also store encrypted security information. The encrypted security information may be utilized to provide a “second factor” method of authentication prior to triggering execution of payment instructions.

For example, smart card 100 may package information entered by a user via touch-sensitive 105 into payment instructions. The payment instructions may include a PIN associated with smart card 100. The payment instructions may be submitted for execution to a payment gateway without requiring any further input from a user. The payment instructions may be transferred to the payment gateway using wireless circuitry 103.

After a payment gateway receives transaction instructions formulated by smart card 100, the payment gateway may first verify that the PIN included in the payment instructions is associated with smart card 100. For example, the payment gateway may communicate with a remote payment processing server operated by the issuer and determine whether the received PIN is associated with user name 113 and/or PAN 107.

As a second factor method of authentication, the payment gateway may determine whether the PIN included in the payment instructions successfully unlocks encrypted security information stored on chip 101. If the PIN successfully unlocks the encrypted security information, the payment gateway may execute the received payment instructions.

Smart card 100 may be any suitable size. FIG. 1 shows that smart card 100 has width w and length l. For example, width w may be 53.98 millimeters (“mm”). Length l may be 85.60 mm. Smart card 100 has thickness t. An illustrative thickness t may be 0.8 mm. An exemplary form factor of smart card 100 may be 53.98 mm×85.60 mm×0.8 mm. Such an exemplary form factor may allow smart card 100 to conveniently fit into a user's wallet or pocket. This exemplary form factor may allow smart card 100 to fit into a card reader of an ATM or POS terminal.

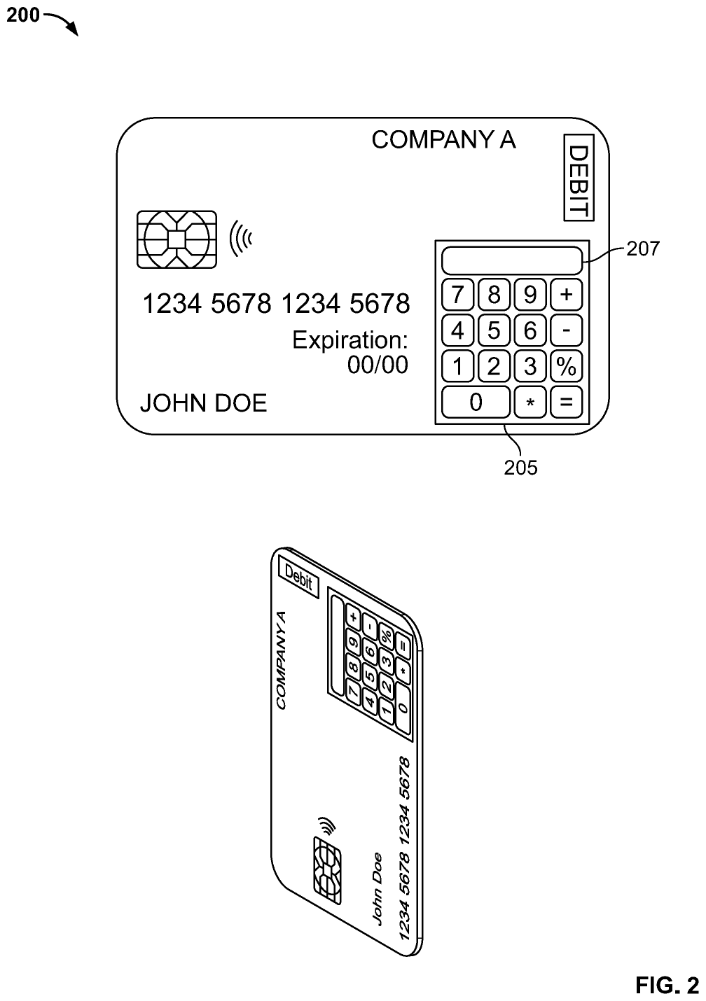

FIG. 2 shows an exemplary smart card, illustrative smart card 200. Smart card 200 may include one or more of the features of smart card 100. Smart card 200 includes virtual keypad 205. Keypad 205 may be used by a user of smart card 100 to enter information which may be displayed on screen 207. Exemplary information may include a PIN number.

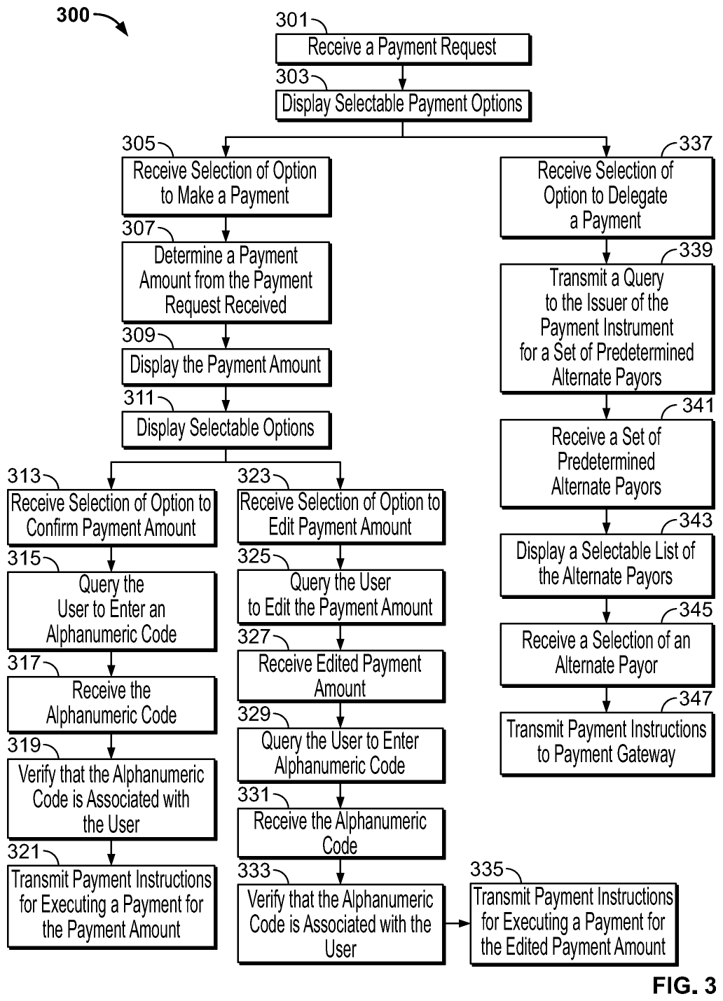

FIG. 3 shows illustrative process flow 300 for transmitting payment instructions from a smart card. Process 300 may begin with step 301. At step 301 the smart card receives a payment request from a merchant or smart card issuer. At step 303 the smart card displays selectable payment options.

One of the displayed payment options may be an option to make a payment. At step 305 the payment option received is the option to make a payment. At step 307 the smart card determines a payment amount from the payment request received. At step 309 the smart card displays the payment amount. At step 311 the smart card displays selectable payment options such as an option to confirm the payment amount or an option to edit the payment amount.

At step 313 the smart card receives a selection of the option to confirm the payment amount. At step 315 the smart card queries the user to enter an alphanumeric code. At step 317 the smart card receives the alphanumeric code. At step 319 the smart card verifies that the alphanumeric code is associated with the user. At step 321 the smart card transmits payment instructions for executing a payment for the payment amount.

The selectable payment options displayed at step 311 may include an option to edit a payment. At step 323 the smart card receives the selection of the option to edit the payment amount. At step 325 the smart card queries the user to edit the payment amount. At step 327 the smart card receives an edited payment amount. At step 329 the smart card queries the user to enter an alphanumeric code. At step 331 the smart card receives an alphanumeric code. At step 333 the smart card verifies that the alphanumeric code is associated with the user. At step 335 the smart card transmits payment instructions for executing a payment for the edited payment amount.

The selectable payment options displayed at step 303 may include an option to delegate a payment. At step 337 the smart card receives a selection of an option to delegate a payment. At step 339 the smart card transmits a query to the issuer of the smart card for a set of predetermined alternate payors. At step 341 the smart card receives a set of predetermined alternate payors. At step 343 the smart card displays a selectable list of the alternate payors. At step 345 the smart card receives a selection of an alternate payor. At step 347 where the smart card may transmit payment instructions to the payment gateway.

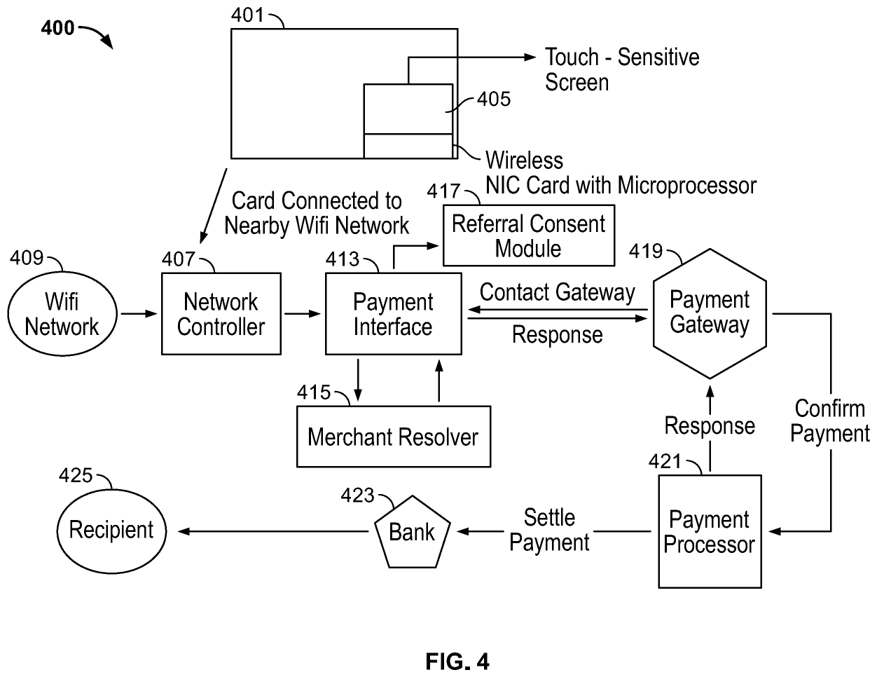

FIG. 4 shows exemplary system architecture 400 according to aspects of the disclosure. System architecture 400 includes smart card 401. Smart card 401 may include one or more features of smart cards 100 and 200. Smart card 401 includes touch-sensitive screen 405, which may include one or more features of touch-sensitive screen 105.

FIG. 4 shows an exploded view of smart card 401 components network interface controller (NIC) 407 and payment interface 413. NIC 407 may include its own dedicated microprocessor and memory. NIC 407 may be a microelectromechanical device that fits within the small form factor associated with smart card 401. In other embodiments, smart card 401 may include another microprocessor for performing other functions. NIC 407 may prepare data generated by a microprocessor on smart card 401 for transmission to a payment gateway or other secure computer system.

FIG. 4 shows that smart card 401 connects to Wi-Fi network 409 using NIC 407. NIC 407 may also be utilized for electronic communication with payment interface 413. Payment interface 413 may interact with touch-sensitive screen 405 to determine payment information associated with selectable payment option captured by touch-sensitive screen 405. Based on the payment option identified by payment interface component 415, smart card 401 establishes a secure communication channel with payment gateway 417. Components 405, 407, 413 and 415 are all resident on smart card 401.

A network address associated with payment gateway 417 may be identified based on a selectable payment option identified by payment interface component 413. In other embodiments, the network address of a payment gateway may be hardwired into NIC 407. In other embodiments, the network address of a payment gateway may be identified from information received by smart card 401.

The system may be configured to determine whether smart card 401 is associated with sufficient funds to process the transaction. Payment gateway 417 may perform one or more checks to verify transaction instructions received from smart card 401. For example, payment gateway 417 may prompt a user of smart card 401 to provide authorization, which may include entering a PIN into touch-sensitive screen 405. In some embodiments, smart card 401 may self-initiate the verification.

After authenticating transaction instructions received from smart card 401, payment gateway 417 may submit the payment instructions to payment processor 419 for settlement. Payment processor 419 may ensure that funds corresponding to the payment amount are debited from an account associated with smart card 401. Payment processor 419 may ensure that funds corresponding to the payment amount are credited to an account associated with payment recipient 423. Bank 421 may facilitate settlement of funds among payment recipient 423 and accounts associated with smart card 401. Bank 421 may be an issuer of smart card 401. Bank 421 may be an acquirer associated with payment recipient 423.

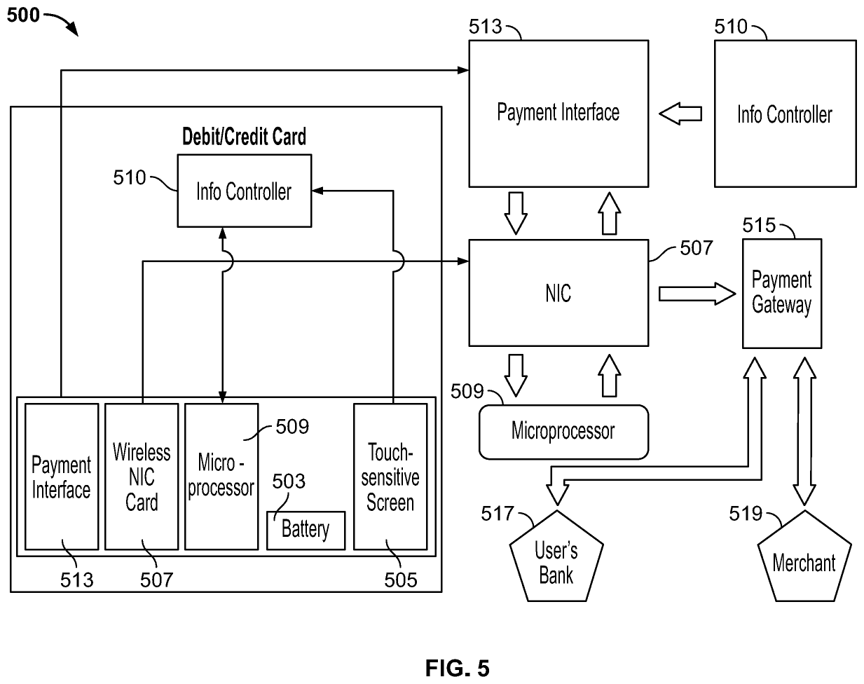

FIG. 5 shows another exemplary system architecture including smart card 500 according to aspects of the disclosure. Smart card 500 may include one or more features of smart cards 100, 200, or 401. Smart card 500 includes information controller 510. Information controller 510 may capture data entered using the touch-sensitive screen 505. Information controller 510 may, in some embodiments, encrypt data captured by touch-sensitive screen 505. Illustrative encryption algorithms include RSA cryptography, Blowfish, AES, RC4, RC5, and RC6. Input controller 510 may store captured data locally on smart card 500.

Smart card 500 includes microprocessor 509 which controls overall operation of smart card 500 and its associated components. For example, microprocessor 509 may control operation of NIC 507 and communication with payment gateway 515.

Microprocessor 509 may formulate transaction instructions for a payment destined for merchant 519. The payment may be forwarded to merchant 519 via payment gateway 515. In some embodiments, smart card 500 may be configured to directly communicate with merchant 519. For example, smart card 500 may communicate a query to merchant 519 for an amount owed, and may receive a figure in response. As another example, after a successful execution of the payment by payment gateway 515, smart card 500 may receive confirmation from merchant 519. The confirmation may be displayed on touch-sensitive screen 505 of smart card 500.

Microprocessor 509 may formulate payment instructions destined for user's bank 517. Such payment instructions may be forwarded to user's bank 517 by payment gateway 515. In some embodiments, smart card 500 may be configured to directly communicate with user's bank 517. For example, user's bank 517 may request authentication, such as a PIN, before debiting an account associated with smart card 500 based on received payment instructions.

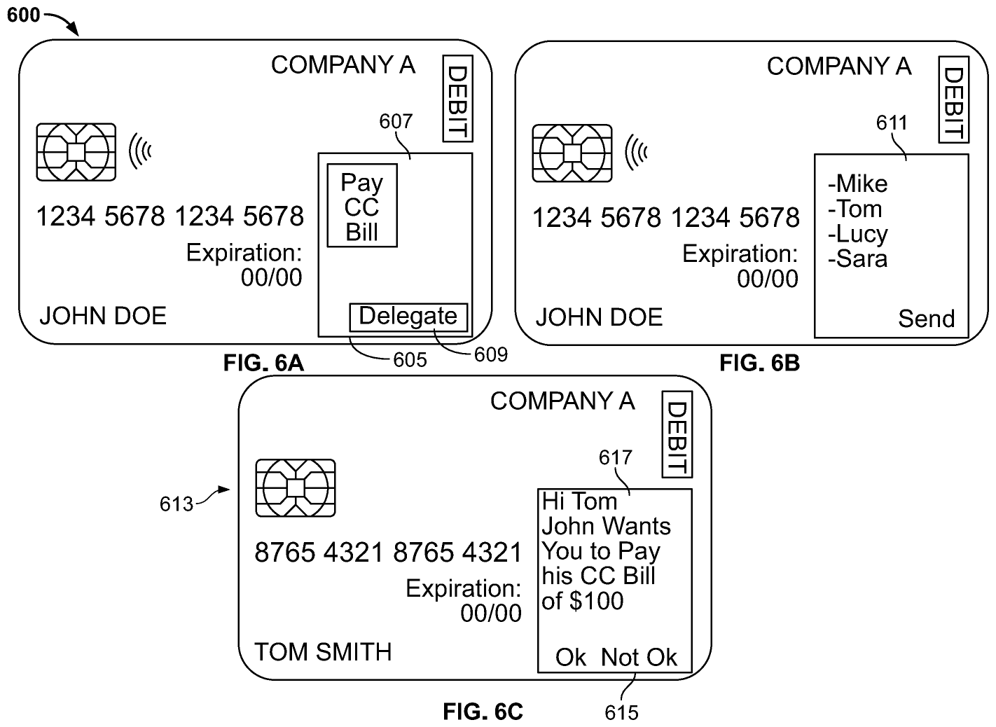

FIG. 6A-6B shows views of another exemplary smart card, illustrative smart card 600. Smart card 600 may include one or more of the features of smart card 100 and 200.

Smart card 600 includes touch-sensitive screen 605. Touch-sensitive screen 605 may include one or more of the features of touch-sensitive screen 105 and 205. Touch-sensitive screen 605 may be used by a user of smart card 600 to enter information. Exemplary information may include a selectable payment option. Touch screen 605 is displaying the selectable payment option 607 to pay a credit card bill and a selectable payment option 609 to delegate the payment.

In some embodiments, the payment option selected may be an option to delegate a payment. In response to the selection to delegate a payment the smart card 600 may display a selectable list 611 of preapproved alternate payors. The smart card may receive a selection of an alternate payor from the touch-sensitive screen 605.

Smart card 600 may establish a direct communication channel with a secure payment gateway. The location of the secure payment gateway may be determined based on a payment option. The payment option selected is to delegate a payment. Smart card 600 will then communicate with the secure payment gateway so a payment request is sent to an alternate payor's smart card 613.

FIG. 6C shows views of a second smart card 613 belonging to an alternate payor. Smart card 613 may include one or more of the features of smart card 100, 200, and 600.

Smart card 613 includes touch-sensitive screen 615. Touch-sensitive screen 615 may include one or more of the features of touch-sensitive screen 105, 205, 605. Smart card 613 is displaying request 617 for the alternate payor to make the payment.

Thus, systems, methods, and apparatus for SMART CARD PROVIDING SELECTABLE PAYMENT OPTIONS are provided. Persons skilled in the art will appreciate that the present invention can be practiced by other than the described embodiments, which are presented for purposes of illustration rather than of limitation, and that the present invention is limited only by the claims that follow.

What is claimed is:

1. A smart card with self-contained transaction architecture for providing secure payment options, the smart card comprising:
a microprocessor;
a touch-sensitive screen;
a power source for providing power to the microprocessor and the touch-sensitive screen;
a wireless interface configured to provide wireless communication;
a payment interface; and
a non-transitory memory storing computer-executable instructions, that, when run on the microprocessor,
receive via the wireless interface a payment request, the payment request comprising a payment amount and a recipient;
display selectable payment options on the touch-sensitive screen;
receive a selection of a payment option via the touch-sensitive screen; and
based on the payment option selected, transmit via the payment interface and the wireless interface, payment instructions for executing a payment;
wherein the card comprising metal and/or plastic; and
wherein the card includes dimensions that conform to the ISO/IEC 7810 ID-1 standard, the dimensions being no greater than 86 millimeters×54 millimeters×0.8 millimeters.

2. The smart card of claim 1 wherein the payment option selected is an option to delegate a payment, and the computer-executable instructions, when run by the microprocessor:
transmit a query to the issuer of the smart card for a set of predetermined alternate payors;
in response to the query, receive via the wireless interface a set of predetermined alternate payors;
display a selectable list of the alternate payors on the touch-sensitive screen; and
receive a selection of an alternate payor via the touch-sensitive screen.

3. The smart card of claim 1 wherein the payment option selected is an option to make a payment, and the computer-executable instructions, when run by the microprocessor:
determine a payment amount from the payment request received;
display the payment amount on the touch-sensitive screen;
query the user to confirm the payment amount on the touch-sensitive screen;
receive the confirmation via touch-sensitive screen;
query the user to enter an alphanumeric code via the touch-sensitive screen before transmitting the payment instructions, the payment instructions comprising the payment amount;
receive the alphanumeric code via the touch-sensitive screen; and
verify that the alphanumeric code is associated with the user.

4. The smart card of claim 1 wherein the payment option selected is an option to edit the payment amount, and the computer-executable instructions, when run by the microprocessor:
determine a payment amount via the payment request received;
display the payment amount on the touch-sensitive screen;
query the user to edit the payment amount on the touch-sensitive screen;
receive an edited payment amount via the touch-sensitive screen;
query the user to enter an alphanumeric code via the touch-sensitive screen before transmitting the payment instructions, the payment instructions comprising the edited payment amount;
receive the alphanumeric code via the touch-sensitive screen; and
verify that the alphanumeric code is associated with the user.

5. The smart card of claim 1 wherein the payment interface is configured to:
determine a network address of a payment gateway, the determination based on the payment option selected; and
transmit the payment instructions to the payment gateway.

6. The smart card of claim 1, wherein:
the wireless interface is a nano wireless network interface card (“NIC”);
the power source is rechargeable via solar energy, inductive charging, and/or a charging port; and
the microprocessor, the power source, the wireless interface, the payment interface, the touch-sensitive screen, and the memory are embedded in the card.

7. A system for providing a multiplicity of secure payment options, the system comprising a smart card with self-contained transaction architecture, wherein the smart card is metal and/or plastic and having dimensions that conform to the ISO/IEC 7810 ID-1 standard, said dimensions being no greater than 86 millimeters×54 millimeters×0.8 millimeters, the system comprising:
a microprocessor embedded in the smart card;
a touch-sensitive screen that is affixed to the smart card and exposed on a surface of the smart card;
a power source for the microprocessor and the touch-sensitive screen, the power source that is embedded in the smart card and is rechargeable via solar energy, inductive charging, and/or a charging port;
a wireless interface configured to provide wireless communication, wherein the wireless interface is a nano wireless network interface card (“NIC”) that is embedded in the smart card; and
a non-transitory memory embedded in the smart card and storing computer-executable instructions, that, when run on the microprocessor, are configured to:
receive, via the wireless interface, a payment request, the payment request comprising a payment amount and a recipient;
display selectable payment options on the touch screen;
receive a selection of a payment option via the touch-sensitive screen; and
based on the payment option selected, transmit via the payment interface and the wireless interface, payment instructions to execute a payment.

8. The system of claim 7 wherein the payment option selected is an option to delegate a payment, the computer-executable instructions, when run by the microprocessor:
transmit a query to the issuer of the smart card for a set of predetermined alternate payors;
in response to the query, receive via the wireless interface a set of predetermined alternate payors;
display a selectable list of the alternate payors on the touch-sensitive screen;
receive a selection of an alternate payor via the touch-sensitive screen.

9. The system of claim 7 wherein the payment option selected is an option to make a payment, the computer-executable instructions, when run by the microprocessor:
determine a payment amount from the payment request received;
display the payment amount on the touch-sensitive screen;
query the user to confirm the payment amount on the touch-sensitive screen;
receive the confirmation via touch-sensitive screen;
query the user to enter an alphanumeric code via the touch-sensitive screen before transmitting the payment instructions, the payment instructions comprising the payment amount;
receive the alphanumeric code via the touch-sensitive screen; and
verify that the alphanumeric code is associated with the user.

10. The system of claim 7 wherein the payment option selected is the option to edit the payment amount, the computer-executable instructions, when run by the microprocessor:
determine a payment amount from the payment request received;
display the payment amount on the touch-sensitive screen;
query the user to edit the payment amount on the touch-sensitive screen;
receive an edited payment amount via the touch-sensitive screen;
query the user to enter an alphanumeric code via the touch-sensitive screen before transmitting the payment instructions, the payment instructions comprising the edited payment amount;
receive the alphanumeric code via the touch-sensitive screen; and
verify that the alphanumeric code is associated with the user.

11. The system of claim 7 wherein the payment interface is configured to:
determine a network address of a payment gateway, the determination based on the payment option selected; and
transmit the payment instructions to the payment gateway.

12. A method for executing a multiplicity of secure payment options via a smart card with self-contained transaction architecture, the method executed via computer-executable instructions that are stored in a non-transitory memory of the smart card and run on a microprocessor embedded in the smart card, the method comprising:
receiving a payment request via a wireless interface that is embedded in the smart card, the payment request comprising a payment amount and a recipient;
displaying selectable payment options on a touch-sensitive screen that is affixed to the smart card;
receiving a selection of a payment option via the touch-sensitive screen; and
based on the payment option selected, transmitting via a payment interface that is embedded in the smart card and the wireless interface, payment instructions to execute a payment.

13. The method of claim 12 wherein the payment option selected is an option to delegate a payment, the method further comprising:
transmitting a query to the issuer of the smart card for a set of predetermined alternate payors;
in response to the query, receiving via the wireless interface a set of predetermined alternate payors;
displaying a selectable list of the alternate payors on the touch-sensitive screen;
receiving a selection of an alternate payor via the touch-sensitive screen.

14. The method of claim 12 wherein the payment option selected is an option to make a payment, the method further comprising:
determining a payment amount from the payment request received;
displaying the payment amount on the touch-sensitive screen;
querying the user to confirm the payment amount on the touch-sensitive screen;
receiving the confirmation via touch-sensitive screen;
querying the user to enter an alphanumeric code via the touch-sensitive screen before transmitting the payment instructions, the payment instructions comprising the payment amount;
receiving the alphanumeric code via the touch sensitive screen; and
verifying that the alphanumeric code is associated with the user.

15. The method of claim 12 wherein the payment option selected is the option to edit the payment amount, the method further comprising:
determining a payment amount from the payment request received;
displaying the payment amount on the touch-sensitive screen;
querying the user to edit the payment amount on the touch-sensitive screen;
receiving an edited payment amount from the touch-sensitive screen;
querying the user to enter an alphanumeric code via the touch-sensitive screen before transmitting the payment instructions, the payment instructions comprising the edited payment amount;
receiving the alphanumeric code via the touch-sensitive screen; and
verifying that the alphanumeric code is associated with the user.

16. The method of claim 12 wherein:
the card comprising metal and/or plastic;
the wireless interface is a nano wireless network interface card (“NIC”);
the card comprises a power source to power the microprocessor and the touch sensitive screen, and the power source is rechargeable via solar energy, inductive charging, and/or a charging port;
the card includes dimensions that conform to the ISO/IEC 7810 ID-1 standard, the dimensions being no greater than 86 millimeters×54 sensitive screen is affixed to the card and exposed on a surface of the card.
